(19) United States
(12) Patent Application Publication
(10) Pub. No.: US 2017/0283602 A1
(43) Pub. Date: Oct. 5, 2017

(54) RUBBER COMPOSITION, AND RUBBER PRODUCT PRODUCED BY USING THE RUBBER COMPOSITION

(71) Applicant: SUMITOMO RUBBER INDUSTRIES, LTD., Kobe-shi (JP)

(72) Inventor: Masashi HAMAKUBO, Kobe-shi (JP)

(73) Assignee: SUMITOMO RUBBER INDUSTRIES, LTD., Kobe-shi (JP)

(21) Appl. No.: 15/465,180

(22) Filed: Mar. 21, 2017

(30) Foreign Application Priority Data
Apr. 5, 2016 (JP) 2016-075609

(51) Int. Cl. C08L 23/16; B65H 27/00; C08K 13/02

(52) U.S. Cl. CPC C08L 23/16; C08K 13/02; B65H 27/00; C08L 2312/00; B65H 2401/111; B65H 2801/03; B65H 2701/1912

(57) ABSTRACT

An inventive rubber composition contains a rubber component including EPDM, a peroxide crosslinking agent, a white filler, and not less than 0.1 part by mass of a quaternary ammonium salt based on 100 parts by mass of the rubber component. An inventive molded rubber product (1) is made from the rubber composition. Thus, the novel rubber composition containing the rubber component including the EPDM, the peroxide crosslinking agent and the white filler can be imparted with any desired color (e.g., a light color such as white or a non-black color) and can form a molded rubber product excellent in strain resistance properties and the like without inhibition of the crosslinking of the EPDM. The molded rubber product is produced by using the rubber composition.

### TECHNICAL FIELD

The present invention relates to a rubber composition, and a rubber product such as a sheet conveying roller produced by using the rubber composition.

### BACKGROUND ART

In general, carbon black is used as a rubber reinforcing agent. The carbon black is black as implied by its name, so that molded rubber products containing, the carbon black are basically black. Therefore, the carbon black is not suitable for production of a molded rubber product having a light color such as white or a non-black color.

Of the molded rubber products, a sheet conveying roller to be incorporated in an electrophotographic image forming apparatus (e.g., a laser printer), an inkjet printer, an automatic teller machines (ATM) or the like preferably has a non-black color for preventing a paper sheet from being smeared with a friction trace.

The influence of the color of the carbon black may be conceivably suppressed by reducing the proportion of the carbon black. In this case, however, the reinforcing effect is insufficient. Particularly, the resulting molded rubber product is liable to be insufficient in mechanical properties, e.g., strain resistance properties such as tensile set and compression set, tensile properties such as tensile strength and breakage elongation, and wear resistance.

In the case of the sheet conveying roller, for example, the tensile set is particularly increased. Therefore, the sheet conveying roller is liable to have a reduced slip torque to cause slip rotation during a sheet conveying operation. Further, the compression set is increased, so that the sheet conveying roller is liable to be deformed to be indented when being kept in contact with a part of other roller for a longer period of time.

Therefore, it is contemplated to blend a white filler such as clay, zinc oxide or titanium oxide instead of the carbon black or together with a small amount of the carbon black.

Further, the sheet conveying roller is required to be excellent in ozone resistance and weather resistance for use in an image forming apparatus, and is required to be excellent in weather resistance, thermal aging resistance, cold resistance and low-temperature properties to ensure stable performance when being incorporated in an ATM which may be installed in various places. Therefore, ethylene propylene diene rubber (EPDM) which is excellent in these properties is often used for production of the sheet conveying roller.

Where the clay is added as the reinforcing agent to a system containing the EPDM as a rubber component and a peroxide as a crosslinking agent, the clay inhibits the crosslinking of the EPDM with the peroxide crosslinking agent. Therefore, the addition of the clay adversely reduces the strain resistance properties and the like due to impossible crosslinking or insufficient crosslinking.

Zinc oxide and titanium oxide do not inhibit the crosslinking and, therefore, make it possible to impart the molded rubber product with proper strain resistance properties and the like. However, further improvement in strain resistance properties and the like is required in some cases.

### CITATION LIST

### [Patent Document]

[PATENT DOCUMENT 1] JP2003-107932A

### SUMMARY OF THE INVENTION

### Problem to be Solved by the Invention

It is an object of the present invention to provide a novel rubber composition which contains a rubber component including EPDM, a peroxide crosslinking agent and a white filler, and can be imparted with any desired color (e.g., a light color such as white) and can form a molded rubber product excellent in strain resistance properties and the like without inhibition of the crosslinking of the EPDM, and to provide a molded rubber product produced by using the rubber composition.

### Solution to Problem

According to the present invention, there is provided a rubber composition which contains a rubber component including EPDM, a peroxide crosslinking agent, a white filler, and not less than 0.1 part by mass of a quaternary ammonium salt based on 100 parts by mass of the rubber component.

According to the present invention, there is also provided a molded rubber product made from the inventive rubber composition.

### Effects of the Invention

According to the present invention, the novel rubber composition containing the rubber component including the EPDM, the peroxide crosslinking agent and the white filler can be imparted with any desired color (e.g., alight color such as white) and can form a molded rubber product excellent in strain resistance properties and the like without inhibition of the crosslinking of the EPDM. The molded rubber product made from the rubber composition is also provided.

### BRIEF DESCRIPTION OF THE DRAWINGS

FIG. 1 is a perspective view illustrating a sheet conveying roller as an exemplary molded rubber product according to one embodiment of the present invention.

FIG. 2 is a diagram for explaining how to measure the friction coefficient of each of sheet conveying rollers produced by using rubber compositions of inventive examples and comparative examples.

### EMBODIMENTS OF THE INVENTION

### <<Rubber Composition>>

A rubber composition according to the present invention contains a rubber component including EPDM, a peroxide crosslinking agent, a white filler, and not less than 0.1 part by mass of a quaternary ammonium salt based on 100 parts by mass of the rubber component.

According to the present invention, where the quaternary ammonium salt is added in the predetermined proportion to a system containing the rubber component including the EPDM, the peroxide crosslinking agent and the white filler and clay is used as the white filler, as apparent from the results for inventive examples and comparative examples to be described later, the clay is prevented from inhibiting the crosslinking of the EPDM, making it possible to produce a molded rubber product excellent in strain resistance properties and the like.

Where zinc oxide and/or titanium oxide is used as the white filler, the molded rubber product is imparted with more excellent strain resistance properties than a molded rubber product made from a rubber composition containing no quaternary ammonium salt.

In Patent Document 1, it is stated that a quaternary ammonium salt is added to a system containing a rubber component and a peroxide crosslinking agent. However, the quaternary ammonium salt is added as an electrical conductivity imparting agent (paragraph) [0015]), and carbon black is added as a reinforcing agent (paragraph [0031]), so that the resulting molded rubber product is black.

In Patent Document 1, the effect is actually confirmed only where a millable urethane rubber is used as the rubber component, but there is no description that the inhibition of the crosslinking of the EPDM is prevented and the strain resistance properties and the like of the molded rubber product are improved by adding the quaternary ammonium salt to the system containing the EPDM as the rubber component.

### <EPDM>

Usable as the EPDM are various EPDMs which are prepared by introducing double bonds to a main chain of the EPDM by addition of a small amount of a third ingredient (diene) to ethylene and propylene.

A variety of EPDM products produced, for example, by using different types and different amounts of the third ingredient are commercially available. Typical examples of the third ingredient include ethylidene norbornene (ENB), 1,4-hexadiene (1,4-HD) and dicyclopentadiene (DCP).

The EPDM may be of an oil-extension type having flexibility controlled by addition of an extension oil or of a non-oil-extension type containing no extension oil. In the present invention, either type of EPDM is usable.

These EPDMs may be used alone or in combination.

### <Additional Rubber>

The EPDM (which may include two or more types of EPDMs) is preferably used alone as the rubber component for improvement of the ozone resistance and the like of the molded rubber product and for simplification of the formulation of the rubber composition for cost reduction.

However, an additional rubber may be used in combination with the EPDM as the rubber component.

Examples of the additional rubber include natural rubber, isoprene rubber (IR) and styrene butadiene rubber (SBR). The SBR may be of an oil-extension type having flexibility controlled by addition of an extension oil or of a non-oil-extension type containing no extension oil. Either type of SBR is usable.

Where a sheet conveying roller is formed from the rubber composition, for example, the combinational use of the additional rubber and the EPDM suppresses reduction in the friction coefficient μ of the sheet conveying roller which may otherwise occur due to accumulation of paper dust when a sheet conveying operation is repeatedly performed, and improves the wear resistance of the sheet conveying roller.

Where the additional rubber is used in combination with the EPDM, the proportion of the additional rubber is preferably not greater than 40 parts by mass, particularly preferably not greater than 35 parts by mass, based on 100 parts by mass of the overall rubber component.

If the proportion of the additional rubber is greater than the aforementioned range, the proportion of the EPDM is relatively reduced, so that the effect of the use of the EPDM for improving the ozone resistance and the like of the molded rubber product is liable to be insufficient.

In order to advantageously provide the aforementioned effect of the combinational use of the EPDM and the additional rubber, the proportion of the additional rubber is preferably not less than 5 parts by mass, particularly preferably not less than 10 parts by mass, based on 100 parts by mass of the overall rubber component within the aforementioned range.

### <Peroxide Crosslinking Agent>

Examples of the peroxide crosslinking agent include benzoyl peroxide, 1,1-bis(tert-butylperoxy)-3,3,5-trimethylcyclohexan e, 2,5-dimethyl-2,5-di(benzoylperoxy)hexane, di(tert-butylperoxy)diisopropylbenzene, 1,4-bis[(tert-butyl)peroxyisopropyl]benzene, di(tert-butylperoxy)benzoate, tert-butylperoxybenzoate, dicumyl peroxide (DCP), tert-butyl cumyl peroxide, 2,5-dimethyl-2,5-di(tert-butylperoxy)hexane, di-tert-butyl peroxide and 2,5-dimethyl-2,5-di(tert-butylperoxy)-3-hexene.

The proportion of the peroxide crosslinking agent is preferably not less than 1 part by mass and not greater than 10 parts by mass, particularly preferably not greater than 5 parts by mass, based on 100 parts by mass of the overall rubber component.

If the proportion of the peroxide crosslinking agent is less than the aforementioned range, the crosslinking is liable to be insufficient, making it impossible to produce a molded rubber product excellent in strain resistance properties and the like.

Even if the proportion of the peroxide crosslinking agent is greater than the aforementioned range, on the other hand, it will be impossible to further enhance the intended effect, and scorching is liable to occur during processing or molding.

Where the proportion of the peroxide crosslinking agent falls within the aforementioned range, in contrast, the rubber composition can be sufficiently crosslinked without the scorching, making it possible to produce a molded rubber product excellent in strain resistance properties and the like.

Where an oil-extension type rubber such as the oil-extension type EPDM or the oil-extension type SBR is used, the proportion of the peroxide crosslinking agent is based on the solid amount of the rubber component that is calculated by subtracting the amount of the extension oil contained in the oil-extension type rubber from the amount of the rubber component. This also applies to the following ingredients other than the peroxide crosslinking agent.

### <White Filler>

Usable as the white filler are various fillers which each function as a filler/reinforcing agent for the rubber component including the EPDM and basically have a white or light color.

Examples of the white filler include clay, talc, magnesium carbonate, aluminum hydroxide, zinc oxide, titanium oxide and calcium carbonate.

Particularly, at least one of clay, zinc oxide and titanium oxide is preferably used as the white filler.

Particularly, the use of the clay in combination with the quaternary ammonium salt significantly improves the strain resistance properties and the like of the molded rubber product without inhibition of the crosslinking of the EPDM with the peroxide crosslinking agent.

Usable examples of the clay include hard clay, soft clay and activated clay, which are produced by smelting natural mineral mainly composed of hydrous aluminum silicate and are classified according to the modulus of a rubber composition prepared by adding the clay to a rubber. Particularly, the hard clay is preferred for a reinforcing effect.

The proportion of the clay is preferably not less than 10 parts by mass and not greater than 25 parts by mass based on 100 parts by mass of the overall rubber component.

If the proportion of the clay is less than the aforementioned range, the reinforcing effect of the addition of the clay is liable to be insufficient, thereby reducing the strain resistance properties, the tensile properties and the wear resistance of the molded rubber product.

If the proportion of the clay is greater than the aforementioned range, on the other hand, the crosslinking of the EPDM will be inhibited even with the use of the quaternary ammonium salt. As a result of impossible crosslinking or insufficient crosslinking, the strain resistance properties, the tensile properties and the wear resistance of the molded rubber product may be reduced.

Further, the proportion of the rubber component is relatively reduced, so that the rubber composition is liable to have poorer processability, and the molded rubber product is liable to be harder and more brittle. This may adversely reduce the tensile properties and the wear resistance of the molded rubber product.

Where the proportion of the clay falls within the aforementioned range, in contrast, the rubber composition has proper processability, and makes it possible to produce a molded rubber product excellent in strain resistance properties, tensile properties and wear resistance while suppressing the inhibition of the crosslinking of the EPDM.

For further improvement of the aforementioned effect, the proportion of the clay is preferably not less than 15 parts by mass and not greater than 20 parts by mass based on 100 parts by mass of the overall rubber component within the aforementioned range.

Basically, zinc oxide and titanium oxide do not inhibit the crosslinking of the EPDM as described above. In addition, the use of zinc oxide and/or titanium oxide in combination with the quaternary ammonium salt significantly increases the strain resistance properties of the molded rubber product.

Examples of zinc oxide include various types of zinc oxide including type-1 to type-3 zinc oxides specified in Japanese Industrial Standards JIS K1410₋₁₉₉₅ “Zinc oxide” and pulverized zinc oxide having smaller particle sizes than these specified zinc oxides.

The proportion of zinc oxide is preferably not less than 5 parts by mass and not greater than 15 parts by mass based on 100 parts by mass of the overall rubber component.

If the proportion of zinc oxide is less than the aforementioned range, the reinforcing effect of the addition of zinc oxide is liable to be insufficient, thereby reducing the strain resistance properties, the tensile properties and the wear resistance of the molded rubber product.

If the proportion of zinc oxide is greater than the aforementioned range, on the other hand, the proportion of the rubber component is relatively reduced, so that the rubber composition is liable to have poorer processability, and the molded rubber product is liable to be harder and more brittle. This may adversely reduce the tensile properties and the wear resistance of the molded rubber product.

Where the proportion of zinc oxide falls within the aforementioned range, in contrast, the rubber composition has proper processability, and makes it possible to produce a molded rubber product excellent in strain resistance properties, tensile properties and wear resistance.

For further improvement of the aforementioned effect, the proportion of zinc oxide is preferably not less than 8 parts by mass and not greater than 12 parts by mass within the aforementioned range.

Examples of titanium oxide include various types of titanium oxides (titanium dioxides) including anatase type, rutile type, mixed crystal type and amorphous type, which are classified according to the crystalline structure thereof.

The proportion of titanium oxide is preferably not less than 10 parts by mass and not greater than 20 parts by mass based on 100 parts by mass of the overall rubber component.

If the proportion of titanium oxide is less than the aforementioned range, the reinforcing effect of the addition of titanium oxide is liable to be insufficient, thereby reducing the strain resistance properties, the tensile properties and the wear resistance of the molded rubber product.

If the proportion of titanium oxide is greater than the aforementioned range, on the other hand, the proportion of the rubber component is relatively reduced, so that the rubber composition is liable to have poorer processability, and the molded rubber product is liable to be harder and more brittle. This may adversely reduce the tensile properties and the wear resistance of the molded rubber product.

Where the proportion of titanium oxide falls within the aforementioned range, in contrast, the rubber composition has proper processability, and makes it possible to produce a molded rubber product excellent in strain resistance properties, tensile properties and wear resistance.

For further improvement of the aforementioned effect, the proportion of titanium oxide is preferably not less than 13 parts by mass and not greater than 17 parts by mass within the aforementioned range.

### <Quaternary Ammonium Salt>

Usable as the quaternary ammonium salt are various quaternary ammonium salts.

Examples of the quaternary ammonium salts include chlorides; bromides and iodides of ammonium ions such as monoalkyltrimethylammonium, dialkyldimethylammonium, trialkylmonomethylammonium, tetraalkylammonium and monoalkyldimethylbenzylammonium.

The quaternary ammonium salt may be added as it is, or in the form of a solution prepared by dissolving the quaternary ammonium salt in water or an alcohol. Particularly, the quaternary ammonium salt is preferably used in the form of an aqueous or alcohol solution.

The ingredients of the rubber composition are blended in the predetermined proportions and kneaded by means of a mixer such as an open roll or a kneader for preparation of the rubber composition. At this time, if the kneading temperature is lower than the melting point of the quaternary ammonium salt, the quaternary ammonium salt is not properly dispersed but agglomerated in the rubber composition.

If the quaternary ammonium salt is not properly dispersed in the rubber composition, the effect of the addition of the quaternary ammonium salt will be insufficient, making it impossible to produce a molded rubber product excellent in strain resistance properties and the like.

Where the quaternary ammonium salt is used in the form of an aqueous or alcohol solution, in contrast, the quaternary ammonium salt can be homogeneously dispersed in the rubber composition without the aforementioned inconvenience, making it possible to produce a molded rubber product excellent in strain resistance properties and the like.

The proportion of the quaternary ammonium salt should be not less than 0.1 part by mass based on 100 parts by mass of the overall rubber component.

If the proportion of the quaternary ammonium salt is less than the aforementioned range when the clay is used as the white filler, for example, the effect for suppressing the inhibition of the crosslinking of the EPDM will be insufficient, making it impossible to crosslink the EPDM. Even if the crosslinking is possible, the strain resistance properties and the like of the molded rubber product may be significantly reduced due to insufficient crosslinking, or the rubber composition may be foamed by the heating during the crosslinking.

Further, if the proportion of the quaternary ammonium salt is less than the aforementioned range when zinc oxide and/or titanium oxide is used as the white filler, it will be impossible to provide the effect of the addition of the quaternary salt for improving the strain resistance properties and the like of the molded rubber product.

In either case, it will be impossible to produce a molded rubber product excellent in strain resistance properties and the like. Particularly, where the molded rubber product is a sheet conveying roller, the sheet conveying roller is liable to have increased tensile set and compression set, thereby suffering from slip rotation, deformation due to compression, and other inconvenience.

Where the proportion of the quaternary ammonium salt falls within the aforementioned range, in contrast, the strain resistance properties and the like of the molded rubber product can be significantly improved.

The proportion of the quaternary ammonium salt is more preferably not greater than 5 parts by mass, particularly preferably not greater than 2 parts by mass, based on 100 parts by mass of the overall rubber component within the aforementioned range.

Even if the proportion of the quaternary ammonium salt is greater than the aforementioned range, it will be impossible to further enhance the aforementioned effect, and an excess amount of the quaternary ammonium salt is liable to bloom on an outer peripheral surface of the sheet conveying roller. This may result in sheet conveying failure and the like.

Where the quaternary ammonium salt is used in the form of an aqueous or alcohol solution, the effective proportion of the quaternary ammonium salt contained in the solution should fall within the aforementioned range.

### <Other Ingredients>

Carbon black may be added as an additional filler/reinforcing agent to the rubber composition.

Usable as the carbon black are various grades of carbon blacks which are capable of functioning as a rubber reinforcing agent.

The proportion of the carbon black is preferably not greater than 3 parts by mass, particularly preferably not greater than 1 part by mass, based on 100 parts by mass of the overall rubber component in consideration of production of a molded rubber product having a light color such as white or a non-black color.

The carbon black may be obviated.

As required, a crosslinking assisting agent, anti-aging agent, an oil, a processing aid, a plasticizing agent, a colorant and the like may be added in proper proportions to the rubber composition.

Usable as the crosslinking assisting agent are various compounds which are capable of assisting the crosslinking of the rubber component with the peroxide crosslinking agent.

Examples of the crosslinking assisting agents include co-crosslinking agents such as higher methacrylates (e.g., trimethylpropane trimethacrylate) and triallylisocyanurate (TRIC), sulfur, dibenzoylquinone dioxime, and 1,2-polybutadiene.

The proportion of the crosslinking assisting agent is preferably not less than 1 part by mass and not greater than 10 parts by mass based on 100 parts by mass of the overall rubber component.

Examples of the oil include various types of process oils for rubbers. Examples of the plasticizing agent include various types of plasticizers such as dibutyl phthalate (DBP), dioctyl phthalate (DOP) and tricresyl phosphate, and various types of waxes such as polar waxes. Further, examples of the processing aid include fatty acids such as stearic acid.

The proportions of the oil, the plasticizing agent and the processing aid may be properly determined according to the required hardness and the like of the molded rubber product.

Where the oil-extension type rubber is used as the rubber component, the addition of the oil may be obviated, or the proportion of the oil may be reduced according to the amount of the extension oil.

### <<Sheet Conveying Roller>>

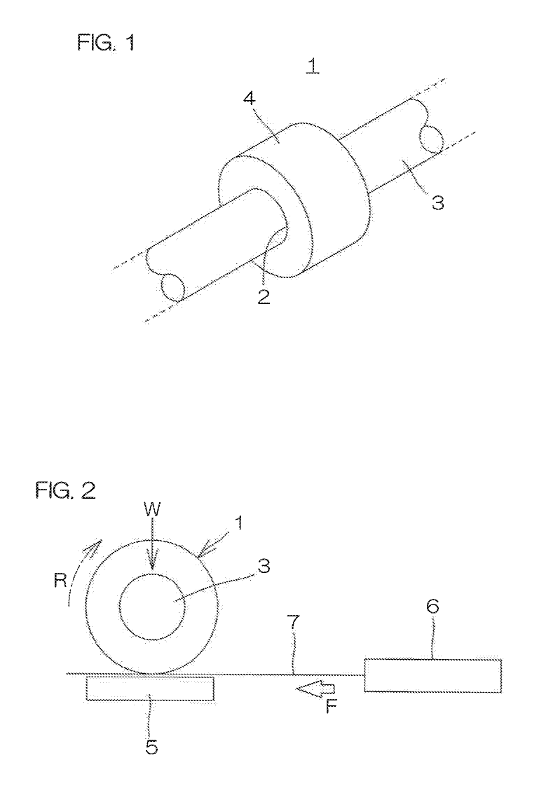

FIG. 1 is a perspective view of a sheet conveying roller as an exemplary molded rubber product according to one embodiment of the present invention.

Referring to FIG. 1, the sheet conveying roller 1 according to this embodiment is produced by forming the inventive rubber composition into a tubular body and crosslinking the tubular body.

The sheet conveying roller 1 has a through-hole 2 having a round cross section and extending along a center line thereof, and a cylindrical shaft 3 is inserted through and fixed to the through-hole 2. An outer peripheral surface 4 of the sheet conveying roller 1 to be brought into contact with a paper sheet has a cylindrical shape coaxial with the through-hole 2 and the shaft 3.

The shaft 3 has an outer diameter that is greater than the inner diameter of the through-hole 2 of the sheet conveying roller 1. The shaft 3 is press-inserted into the through-hole 2 of the sheet conveying roller 1, whereby the sheet conveying roller 1 and the shaft 3 are fixed to each other so as to be free from slip rotation.

That is, an interference defined by a difference in diameter between the through-hole 2 and the shaft 3 provides a predetermined slip torque (a threshold torque that prevents the slip rotation) between the sheet conveying roller 1 and the shaft 3.

The shaft 3 is made of, for example, a metal, a ceramic material, a rigid resin or the like.

A plurality of such sheet conveying rollers 1 may be fixed to different portions of a single shaft 3 as required.

The sheet conveying roller 1 may be produced, for example, by forming the rubber composition into a tubular body by an extrusion method or the like and then crosslinking the tubular body by a press-crosslinking method or the like, or by molding and crosslinking the rubber composition in a tubular shape by a transfer molding method or the like.

As required, the outer peripheral surface 4 of the sheet conveying roller 1 may be polished to a predetermined surface roughness or subjected to a knurling process, an emboss process or the like at any time during the production process.

Further, opposite end portions of the sheet conveying roller 1 may be cut off, so that the outer peripheral surface 4 has a predetermined width.

The outer peripheral surface 4 of the sheet conveying roller 1 may be covered with a given coating layer. The sheet conveying roller 1 may have a double layer structure including an outer layer provided on the side of the outer peripheral surface 4 and an inner layer provide on the side of the through-hole 2. In this case, at least the outer layer is preferably formed from the inventive rubber composition.

The sheet conveying roller 1 preferably has a single layer structure as shown in FIG. 1 for simplification of the structure for production at lower costs with higher productivity.

The sheet conveying roller 1 may have a porous structure, but preferably has a substantially non-porous structure in order to ensure: that the sheet conveying roller 1 is substantially free from reduction in friction coefficient μ and reduction in slip torque with a moderate hardness and a reduced tensile set; that the sheet conveying roller 1 has a reduced compression set and, therefore, is less liable to be deformed to be indented when being kept in contact with a part of other roller for a longer period of time; and that the sheet conveying roller 1 has an improve wear resistance.

The through-hole 2 may extend eccentrically from the center line of the sheet conveying roller 1 depending on the use purpose of the sheet conveying roller 1. Further, the outer peripheral surface 4 of the sheet conveying roller 1 may have an odd shape rather than the cylindrical shape. For example, the outer peripheral surface 4 may have a partly cutaway planar portion.

The odd-shaped sheet conveying roller 1 may be produced by forming the rubber composition directly into an odd-shaped body and then crosslinking the odd-shaped body by the aforementioned production method, or by post-processing the tubular sheet conveying roller 1 into the odd shape.

Further, a shaft 3 having an odd shape conformable to the odd shape of the sheet conveying roller 1 may be press-inserted into the through-hole 2 of the tubular sheet conveying roller 1 so as to deform the sheet conveying roller 1 into the odd shape. In this case, the processability is improved, because the polishing process, the knurling process, the emboss process or the like can be performed on the outer peripheral surface 4 of the tubular sheet conveying roller 1 before the deformation.

### EXAMPLES

### Example 1

### (Preparation of Rubber Composition)

A non-oil-extension type EPDM (ESPRENE (registered trade name) 505A available from Sumitomo Chemical Co., Ltd. and having an ethylene content of 50% and a diene content of 9.5%) was used as a rubber component.

Then, 3 parts by mass of dicumyl peroxide (peroxide crosslinking agent PERCUMYL (registered trade name) D available from NOF Corporation), 20 parts by mass of hard clay (white filler ST-CROWN available from Shiraishi Calcium K.K.), 0.2 parts by mass of carbon black (DIABLACK (registered trade mark) H available from Mitsubishi Chemical Corporation) and 0.7 parts by mass of an aqueous solution of 50% tetrabutylammonium bromide (quaternary ammonium salt TBAB-50A available from Lion Specialty Chemicals Co., Ltd.) were blended with 100 parts by mass of the non-extension-oil type EPDM, and the resulting mixture was kneaded by means of a 3 L kneader and an open roll. Thus, a rubber composition was prepared.

The effective proportion of tetrabutylammonium bromide in the aqueous solution was 0.35 parts by mass based on 100 parts by mass of the overall rubber component (100 parts by mass of the EPDM).

### Comparative Example 1

A rubber composition was prepared in substantially the same manner as in Example 1, except that the proportion of the quaternary ammonium salt aqueous solution was 0.1 part by mass and the effective proportion of tetrabutylammonium bromide in the aqueous solution was 0.05 parts by mass based on 100 parts by mass of the overall rubber component.

### Comparative Example 2

A rubber composition was prepared in substantially the same manner as in Example 1, except that the quaternary ammonium salt aqueous solution was not blended.

### Example 2

As a rubber component, 70 parts by mass of a non-oil-extension type EPDM (ESPRENE 505A available from Sumitomo Chemical Co., Ltd. as described above) and 30 parts by mass of IR (Nipol (registered trade name) IR2200 available from Nippon Zeon Corporation) were used.

Then, 3 parts by mass of dicumyl peroxide (peroxide crosslinking agent PERCUMYL D available from NOF Corporation as described above), 15 parts by mass of hard clay (white filler ST-CROWN available from Shiraishi Calcium K.K. as described above), 0.2 parts by mass of carbon black (DIABLACK H available from Mitsubishi Chemical Corporation as described above) and 2 parts by mass of an aqueous solution of 28% C12 to C16 alkyltrimethylammonium chloride (quaternary ammonium salt ARCARD T-28 available from Lion Specialty Chemicals Co., Ltd.) were blended with 100 parts by mass of the total of the rubbers, and the resulting mixture was kneaded by means of a 3 L kneader and an open roll. Thus, a rubber composition was prepared.

The effective proportion of alkyltrimethylammonium chloride in the aqueous solution was 0.56 parts by mass based on 100 parts by mass of the overall rubber component.

### Example 3

A rubber composition was prepared in substantially the same manner as in Example 2, except that the proportion of the quaternary ammonium salt aqueous solution was 0.4 parts by mass and the effective proportion of alkyltrimethylammonium chloride in the aqueous solution was 0.112 parts by mass based on 100 parts by mass of the overall rubber component.

### Comparative Example 3

A rubber composition was prepared in substantially the same manner as in Example 2, except that the quaternary ammonium salt aqueous solution was not blended.

### Example 4

As a rubber component, 90 parts by mass of a non-oil-extension type EPDM (ESPRENE 505A available from Sumitomo Chemical Co., Ltd. as described above) and 20 parts by mass of an oil-extension type EPDM (ESPRENE 670F available from Sumitomo Chemical Co., Ltd. and having an ethylene content of 66 mass %, a diene content of 4.0 mass % and an extension oil amount of 100 phr) were used.

Then, 1.5 parts by mass of dicumyl peroxide (peroxide crosslinking agent PERCUMYL D available from NOF Corporation as described above), 10 parts by mass of zinc oxide (white filler, zinc oxide type-2 available from Shiraishi Calcium. K.K.), 0.1 part by mass of carbon black (DIABLACK H available from Mitsubishi Chemical Corporation as described above) and 1 part by mass of an aqueous solution of 50% tetrabutylammonium bromide (quaternary ammonium salt TBAB-50A available from Lion Specialty Chemicals Co., Ltd. as described above) were blended with 110 parts by mass of the total of the rubbers (100 parts by mass of an overall solid rubber component), and the resulting mixture was kneaded by means of a 3 L kneader and an open roll. Thus, a rubber composition was prepared.

The effective proportion of tetrabutylammonium bromide in the aqueous solution was 0.5 parts by mass based on 100 parts by mass of the overall rubber component.

### Example 5

A rubber composition was prepared in substantially the same manner as in Example 4, except that the proportion of the quaternary ammonium salt aqueous solution was 0.3 parts by mass and the effective proportion of tetrabutylammonium bromide in the aqueous solution was 0.15 parts by mass based on 100 parts by mass of the overall rubber component.

### Comparative Example 4

A rubber composition was prepared in substantially the same manner as in Example 4, except that the quaternary ammonium salt aqueous solution was not blended.

### Example 6

As a rubber component, 140 parts by mass of an oil-extension type EPDM (ESPRENE 670F available from Sumitomo Chemical Co., Ltd. and having an extension oil amount of 100 phr as described above) and 30 parts by mass of IR (Nipol (registered trade name) IR2200 available from Nippon Zeon Corporation) were used.

Then, 3 parts by mass of dicumyl peroxide (peroxide crosslinking agent PERCUMYL D available from NOF Corporation as described above), 15 parts by mass of titanium oxide (white filler, anatase type SA-1 available from Sakai Chemical Industry Co., Ltd.), 1 part by mass of carbon black (DIABLACK H available from Mitsubishi Chemical Corporation as described above) and 2 parts by mass of an aqueous solution of 50% benzyltrimethylammonium chloride (quaternary ammonium salt BTMAC-50 available from Lion Specialty Chemicals Co., Ltd.) were blended with 170 parts by mass of the total of the rubbers (100 parts by mass of an overall solid rubber component), and the resulting mixture was kneaded by means of a 3 L kneader and an open roll. Thus, a rubber composition was prepared.

The effective proportion of benzyltrimethylammonium chloride in the aqueous solution was 1 part by mass based on 100 parts by mass of the overall rubber component.

### Example 7

A rubber composition was prepared in substantially the same manner as in Example 6, except that the proportion of the quaternary ammonium salt aqueous solution was 1 part by mass and the effective proportion of benzyltrimethylammonium chloride in the aqueous solution was 0.5 parts by mass based on 100 parts by mass of the overall rubber component.

### Comparative Example 5

A rubber composition was prepared in substantially the same manner as in Example 6, except that the quaternary ammonium salt aqueous solution was not blended.

### <Evaluation for Crosslinkability and Moldability/Formability>

The rubber compositions prepared in Examples 1 to 7 and Comparative Examples 1 to 5 were press-crosslinked at 170° C. for 20 minutes. The rubber compositions of Examples 1 to 7 and Comparative Examples 3 to 5 were properly crosslinked and formed into a desired product and, therefore, were rated as having acceptable crosslinkability and moldability/formability (o) and subjected to the following tests to be evaluated for characteristic properties.

The rubber compositions of Comparative Examples 1 and 2 were not properly crosslinked and formed into a desired product and, therefore, were rated as having unacceptable crosslinkability and moldability/formability (x) and were not subjected to the following tests.

### <Hardness Test>

The rubber compositions prepared in Examples 1 to 7 and Comparative Examples 3 to 5 were each press-crosslinked at 170° C. for 20 minutes to be formed into a 2-mm thick sheet, and a test piece was prepared by stacking three such sheets.

The type-A durometer hardness of the test piece was measured at a temperature of 23±2° C. by a measurement method specified in Japanese Industrial Standards JIS K6253-3_{:2012} “Rubber, vulcanized or thermoplastic—Determination of hardness—Part 3: Durometer method” after a lapse of 3 seconds.

### <Tensile Test>

The rubber compositions prepared in Examples 1 to 7 and Comparative Examples 3 to 5 were each press-crosslinked at 170° C. for 20 minutes to be formed into a 2-mm thick sheet, which was in turn stamped. Thus, a dumbbell No. 3 test piece specified in Japanese Industrial Standards JIS K6251_{:2010} “Rubber, vulcanized or thermoplastic—Determination of tensile stress-strain properties” was prepared.

The tensile strength TS (MPa) and the breakage elongation E_{b} (%) of the test piece were determined by performing the tensile test at a temperature of 23±2° C. by a test method specified in Japanese Industrial Standards JIS K6251_{:2010}.

### <Compression Set Test>

The rubber compositions prepared in Examples 1 to 7 and Comparative Examples 3 to 5 were each press-crosslinked at 170° C. for 20 minutes to be formed into a large test piece specified in Japanese Industrial Standards JIS K6262_{:2013} “Rubber, vulcanized or thermoplastic—Determination of compression set at ambient, elevated or low temperatures.”

A compression set test specified in Japanese Industrial Standards JIS K6262_{: 2013} was performed on the large test piece at a temperature of 70° C. for 24 hours to determine the compression set (%) of the test piece.

### <Tensile Set Test>

The rubber compositions prepared in Examples 1 to 7 and Comparative Examples 3 to 5 were each press-crosslinked at 170° C. for 20 minutes to be formed into a 2-mm thick sheet, which was in turn stamped. Thus, a test strip specified in Japanese Industrial Standards JIS K6273_{:2006} “Rubber, vulcanized or thermoplastic—Determination of tensile set, elongation and creep” was prepared.

Then, the constant elongation tensile set TS_{E} (%) of the test strip was determined by stretching the test strip at an elongation of 100% for a test period of 24 hours at a temperature of 23±2° C. by a test method specified in Japanese Industrial Standards JIS K6273_{:2006}.

### <Production of Sheet Conveying Roller>

The rubber compositions prepared in Examples 1 to 7 and Comparative Examples 3 to 5 were each transfer-molded into a cylindrical tubular body at 170° C. for 20 minutes, and a shaft 3 having an outer diameter of 17 mm was press-inserted into a through-hole 2 of the tubular body. In this state, the outer peripheral surface of the tubular body was polished to an outer diameter of 23 mm by means of a cylindrical polishing machine, and then the tubular body was cut to a length of 30 mm. Thus, a sheet conveying roller 1 was produced.

### <Friction Coefficient Test>

A paper sheet 7 having a size of 60 mm×210 mm (a P sheet (plain paper sheet) available from Fuji Xerox Co., Ltd.) was connected to a load cell 6 at one end thereof, and the other end portion of the paper sheet 7 was held between the sheet conveying roller 1 and a polytetrafluoroethylene (PTFE) plate 5 horizontally placed as shown in FIG. 2. In this state, a vertical load W of 1.18 N(=120 gf) was applied to the shaft 3 of the sheet conveying roller 1 as indicated by a solid line arrow in FIG. 2.

In this state, the sheet conveying roller 1 was rotated at a circumferential speed of 300 mm/second in a direction indicated by an arrow of a one-dot-and-dash line at a temperature of 23±2° C. at a relative humidity of 55±10%, and a transport force F (gf) applied to the load cell 6 was measured.

The friction coefficient μ of the sheet conveying roller 1 was determined from the following expression (1) based on the measured transport force F and the vertical load W (=120 gf):

μ=F(gf)/W(gf) (1)

The above results are shown in Tables 1 to 4.

TABLE 1

| | | |
|---|---|---|
| | Comparative | Comparative |
| Example 1 | Example 1 | Example 2 |

Parts by mass
Rubber

| | | | |
|---|---|---|---|
| Non-oil-extension type EPDM | 100 | 100 | 100 |
| Oil-extension type EPDM | — | — | — |
| (solid proportion) | | | |
| IR | — | — | — |
| Peroxide crosslinking agent | 3 | 3 | 3 |

White filler

| | | | |
|---|---|---|---|
| Clay | 20 | 20 | 20 |
| Zinc oxide | — | — | — |
| Titanium oxide | — | — | — |
| Carbon black | 0.2 | 0.2 | 0.2 |

Quaternary ammonium salt (effective proportion)

| | | | |
|---|---|---|---|
| TBAB-50A | 0.35 | 0.05 | — |
| ARCARD T-28 | — | — | — |
| BTMAC-50 | — | — | — |

Evaluation

| | | | |
|---|---|---|---|
| Crosslinkability and moldability/ | ∘ | x | x |
| formability | | | |
| Type-A hardness | 53 | — | — |

Tensile test

| | | | |
|---|---|---|---|
| TS (MPa) | 3.5 | — | — |
| E_{b} (%) | 260 | — | — |
| Compression set (%) | 6 | — | — |
| Constant elongation tensile | 10 | — | — |
| set TS_{E} (%) | | | |
| Friction coefficient μ | 1.7 | — | — |

TABLE 2

| | | |
|---|---|---|
| | | Comparative |
| Example 2 | Example 3 | Example 3 |

Parts by mass
Rubber

| | | | |
|---|---|---|---|
| Non-oil-extension type EPDM | 70 | 70 | 70 |
| Oil-extension type EPDM | — | — | — |
| (solid proportion) | | | |
| IR | 30 | 30 | 30 |
| Peroxide crosslinking agent | 3 | 3 | 3 |

White filler

| | | | |
|---|---|---|---|
| Clay | 15 | 15 | 15 |
| Zinc oxide | — | — | — |
| Titanium oxide | — | — | — |
| Carbon black | 0.2 | 0.2 | 0.2 |

Quaternary ammonium salt (effective proportion)

| | | | |
|---|---|---|---|
| TBAB-50A | — | — | — |
| ARCARD T-28 | 0.56 | 0.112 | — |
| BTMAC-50 | — | — | — |

Evaluation

| | | | |
|---|---|---|---|
| Crosslinkability and moldability/ | ∘ | ∘ | ∘ |
| formability | | | |
| Type-A hardness | 52 | 51 | 45 |

Tensile test

| | | | |
|---|---|---|---|
| TS (MPa) | 2.5 | 2.6 | 3.1 |
| E_{b} (%) | 190 | 210 | 350 |
| Compression set (%) | 8 | 10 | 53 |
| Constant elongation tensile | 3 | 4 | 18 |
| set TS_{E} (%) | | | |
| Friction coefficient μ | 1.8 | 1.8 | 2.2 |

TABLE 3

| | | |
|---|---|---|
| | | Comparative |
| Example 4 | Example 5 | Example 4 |

Parts by mass
Rubber

| | | | |
|---|---|---|---|
| Non-oil-extension type EPDM | 90 | 90 | 90 |
| Oil-extension type EPDM | 10 | 10 | 10 |
| (solid proportion) | | | |
| IR | — | — | — |
| Peroxide crosslinking agent | 1.5 | 1.5 | 1.5 |

White filler

| | | | |
|---|---|---|---|
| Clay | — | — | — |
| Zinc oxide | 10 | 10 | 10 |
| Titanium oxide | — | — | — |
| Carbon black | 0.1 | 0.1 | 0.1 |

Quaternary ammonium salt (effective proportion)

| | | | |
|---|---|---|---|
| TBAB-50A | 0.5 | 0.15 | — |
| ARCARD T-28 | — | — | — |
| BTMAC-50 | — | — | — |

Evaluation

| | | | |
|---|---|---|---|
| Crosslinkability and moldability/ | ∘ | ∘ | ∘ |
| formability | | | |
| Type-A hardness | 42 | 42 | 41 |

Tensile test

| | | | |
|---|---|---|---|
| TS (MPa) | 3.8 | 2.7 | 2.8 |
| E_{b} (%) | 350 | 350 | 405 |
| Compression set (%) | 12 | 13 | 18 |
| Constant elongation tensile | 5 | 5 | 8 |
| set TS_{E} (%) | | | |
| Friction coefficient μ | 1.6 | 1.6 | 1.8 |

TABLE 4

| | | |
|---|---|---|
| | | Comparative |
| Example 6 | Example 7 | Example 5 |

Parts by mass
Rubber

| | | | |
|---|---|---|---|
| Non-oil-extension type EPDM | — | — | — |
| Oil-extension type EPDM | 70 | 70 | 70 |
| (solid proportion) | | | |
| IR | 30 | 30 | 30 |
| Peroxide crosslinking agent | 3 | 3 | 3 |

White filler

| | | | |
|---|---|---|---|
| Clay | — | — | — |
| Zinc oxide | — | — | — |
| Titanium oxide | 15 | 15 | 15 |
| Carbon black | 1 | 1 | 1 |

Quaternary ammonium salt (effective proportion)

| | | | |
|---|---|---|---|
| TBAB-50A | — | — | — |
| ARCARD T-28 | — | — | — |
| BTMAC-50 | 1 | 0.5 | — |

Evaluation

| | | | |
|---|---|---|---|
| Crosslinkability and moldability/ | ∘ | ∘ | ∘ |
| formability | | | |
| Type-A hardness | 36 | 36 | 35 |

Tensile test

| | | | |
|---|---|---|---|
| TS (MPa) | 3.4 | 3.6 | 3.9 |
| E_{b} (%) | 350 | 390 | 500 |
| Compression set (%) | 8 | 9 | 15 |
| Constant elongation tensile | 7 | 8 | 18 |
| set TS_{E} (%) | | | |
| Friction coefficient μ | 2.0 | 2.1 | 2.2 |

The results for Example 1 and Comparative Examples 1 and 2 shown in Table 1 indicate that, where the clay is added as the white filler to the system containing the EPDM alone as the rubber component, the crosslinking of the EPDM is completely inhibited and that, where the quaternary ammonium salt is further added in a proportion of not less than 0.1 part by mass based on 100 parts by mass of the overall rubber component (100 parts by mass of the EPDM), in contrast, the EPDM is properly crosslinked and the resulting molded rubber product is excellent in strain resistance properties and the like.

The results for Examples 2 and 3 and Comparative Example 3 shown in Table 2 indicate that, where the clay is added as the white filler to the system containing the EPDM and the IR as the rubber component, the crosslinking of the IR is not inhibited and, therefore, the resulting molded rubber product has proper strain resistance properties and the like and that, where the quaternary ammonium salt is further added, the strain resistance properties and the like are further improved.

The results for Examples 4 to 7 and Comparative Examples 4 and 5 shown in Tables 3 and 4 indicate that, where zinc oxide or titanium oxide is added as the white filler, the resulting molded rubber product has moderate strain resistance properties and the like without the inhibition of the crosslinking and that, where the quaternary ammonium salt is further added, the strain resistance properties and the like are further improved.

This application corresponds to Japanese Patent Application No. 2016-075609 filed in the Japan Patent Office on Apr. 5, 2016, the disclosure of which is incorporated herein by reference in its entirety.

What is claimed is:

1. A rubber composition comprising a rubber component including ethylene propylene diene rubber, a peroxide crosslinking agent, a white filler, and not less than 0.1 part by mass of a quaternary ammonium salt based on 100 parts by mass of the rubber component.

2. The rubber composition according to claim 1, wherein the ethylene propylene diene rubber is present in a proportion of not less than 65 parts by mass based on 100 parts by mass of the rubber component in the rubber component.

3. The rubber composition according to claim 2, wherein the white filler is at least one selected from the group consisting of clay, talc, magnesium carbonate, aluminum hydroxide, zinc oxide, titanium oxide and calcium carbonate.

4. The rubber composition according to claim 3, wherein the white filler is clay.

5. The rubber composition according to claim 3, wherein the white filler is one of zinc oxide and titanium oxide.

6. The rubber composition according to claim 1, further comprising carbon black.

7. The rubber composition according to claim 6, wherein the carbon black is present in a proportion of not greater than 1 part by mass based on 100 parts by mass of the rubber component.

8. A molded rubber product made from the rubber composition according to claim 1.

9. The molded rubber product according to claim 8, which is a sheet conveying roller.
